(19) United States
(12) Patent Application Publication
(10) Pub. No.: US 2010/0215805 A1
(43) Pub. Date: Aug. 26, 2010

(54) BARRIER-COATED INGREDIENT FOR READY-TO-BAKE COOKIE DOUGH

(76) Inventor: PATRICIA W. HAHN, Plymouth, MN (US)

Correspondence Address: GENERAL MILLS, INC., P.O. BOX 1113, MINNEAPOLIS, MN, 55440, US

(21) Appl. No.: 12/706,124

(22) Filed: Feb. 16, 2010

Related U.S. Application Data
(60) Provisional application No. 61/154,078, filed on Feb. 20, 2009.

(51) Int. Cl. A21D 10/02; A21D 8/04

(52) U.S. Cl. 426/61

(57) ABSTRACT

A ready-to-bake cookie dough product containing a barrier coated cinnamon ingredient is described. The barrier coated cinnamon substantially reduces or eliminates the formation of gray dough in the cookie dough product when the cookie dough product is stored under refrigerated or frozen conditions. The barrier coated cinnamon ingredient includes cinnamon coated with a high SFI fat. Other ingredients, such as spices or flavorings, can also be prepared using the barrier coating to reduce or eliminate the formation of gray dough or other discoloration or forms of deterioration in ready-to-bake dough products.

### CROSS-REFERENCE TO RELATED APPLICATIONS

This application claims the benefit of priority under 35 U.S.C. 119(e)(1) of a provisional patent application Ser. No. 61/154,078, filed Feb. 20, 2009, which is incorporated herein by reference in its entity.

### BACKGROUND

Ready-to-bake dough products, such as refrigerated or frozen dough products, have become very popular over the years due to the convenience of being able to make freshly baked products at home without the hassle and mess of making the dough itself, and the quality of the resulting finished product. Food manufacturers strive to provide consumers with ready-to-bake dough products that result in finished products having organoleptic qualities that are comparable to made-from-scratch products, at a fraction of the time or work involved to make such products from scratch at home. Both food retail and foodservice industries have come to rely on the convenience and quality afforded by ready-to-bake dough products.

To make such ready-to-bake dough products, however, the food manufacturer must deal with issues relating to the fact that once the dough product is prepared, it must be distributed and stored prior to use by the consumer. Storage stability is a significant aspect of ready-to-bake dough products, since poor storage stability adversely affects a dough product during storage, making the dough product unappealing to or unsuitable for use by the consumer. Dough formulation, processing, packaging, distribution and storage are all factors the manufacturer must consider when making ready-to-bake dough products, as each factor can lead to product failure if not properly addressed.

Ready-to-bake cookie dough is an example of a popular ready-to-bake dough product. Ready-to-bake cookie dough can be either refrigerated or frozen, and then easily baked by the consumer to make a freshly baked cookie at home or at the foodservice outlet. Ready-to-bake cookie dough has been sold in the form of “pucks” or rounded discs of dough, cylinders, cubes, chubs, or other forms, and has been sold in larger quantities in tubs or pails from which the consumer scoops the cookie dough out to make the desired number of cookies. Ready-to-bake cookie dough may contain conventional cookie particulates, such as chocolate chips or nuts. However, some cookie particulates that are conventionally used in home baking result in serious problems when the particulate is included in a commercially produced ready-to-bake dough product intended for distribution and storage.

One of the most significant problems associated with any type of ready-to-bake dough product containing particulates, inclusions, or flavorings such as herbs and spices, (hereinafter collectively referred to as “particulates”), is the formation of so-called “gray” dough. Graying of the dough occurs when the enzymes in the dough react with the particulate, or vice versa, resulting in deterioration of the dough, the particulate, or both, and the formation of discolored, translucent, or gray dough. As used herein, “gray dough” shall refer to any dough or portion of dough in which such deterioration has occurred.

An example of a popular cookie dough particulate that causes serious gray dough issues is cinnamon. Cinnamon is a favorite bakery ingredient, adding a desired flavor and aroma to numerous bakery products, such as snickerdoodle cookies. However, when cinnamon is added to a dough, and the dough is stored for a period of time, the dough and the cinnamon react to form gray dough, resulting in an unappealing and unacceptable product. While not intending to be bound by theory, it is believed that phenoloxidase or polyphenoloxidase enzymes in the dough flour react with phenol or polyphenol substrate compounds in cinnamon, thereby turning the surrounding dough gray.

The issue of gray dough in cinnamon-containing dough products has plagued food manufacturers for decades. For leavened dough products having a developed continuous gluten matrix and that are packaged in a pressurized dough can (see, for example, U.S. Pat. No. 6,280,782), it was found that using a barrier around the cinnamon, such as a fat barrier, sequestered the cinnamon from the dough enzymes. The environment in the pressurized dough can is typically oxygen-depleted due to the formation of gas caused by the leavening agents and the resulting expansion of dough inside the package. The depletion of oxygen headspace in the can by the dough expansion is believed to hinder the (poly)phenoloxidase reaction. By sequestering the cinnamon from the high moisture dough environment, and depleting the oxygen in the surrounding environment, the gray dough forming reaction can be reduced.

For cookies, which are significantly different from other bakery products such as cinnamon rolls, one approach has been to simply sprinkle the cinnamon on top of the dough. Although this may reduce the formation of gray dough, as the dough is baked, the cookie dough spreads, but the cinnamon-sprinkled area does not. The resulting cookie topping does not uniformly cover the top surface, and the cinnamon flavor does not permeate the entire cookie, but is instead concentrated on the top center of the cookie. The resulting cookie does not appear or taste similar to a made-from-scratch homemade cinnamon cookie.

Therefore, a significant gray dough problem continues to exist in the area of ready-to-bake cookie dough products containing cinnamon. Prior to the present invention, there have been numerous attempts to resolve this issue, but to date, none of them have been successful.

### SUMMARY OF THE INVENTION

The present invention is directed to the surprising discovery that in a ready-to-bake cookie dough product, providing a barrier coating to a food ingredient, such as cinnamon, using a high SFI fat as the barrier material, reduces or eliminates the formation of gray dough in the dough product during refrigerated or frozen storage. The reduction or elimination of gray dough formation in ready-to-bake cookie dough products of the present invention unexpectedly does not require the use of oxygen-depleted packaging.

### BRIEF DESCRIPTION OF THE DRAWINGS

FIG. 1 is an SFI curve showing the SFI value vs. temperature of a number of fats.

FIG. 2 is a graphical representation of the L values of a number of dough products, including a ready-to-bake cookie dough product made in accordance with the present invention.

### DESCRIPTION

In accordance with the present invention, the use of a barrier to sequester the cinnamon from the ready-to-bake cookie dough during manufacturing, distribution and storage can overcome the gray dough issues and provide a very appealing, high quality baked cinnamon cookie that includes cinnamon particulates throughout the cookie. Ready-to-bake cookie dough is significantly different from other types of dough because cookie dough has a very low moisture content. As a result, there is very little, if any, gluten development in the cookie dough, and there is no continuous gluten matrix—instead, the gluten is present in a discontinuous form. This characteristic of a cookie dough is generally referred to as a “short” dough, since the continuous matrix is fat, rather than the continuous gluten matrix found in extensible higher moisture doughs. In addition, cookie dough generally contains little or no added leavening agents found in other dough products.

It was unexpectedly discovered that the use of barrier-coated cinnamon alone, without the need for an oxygen-depleted environment, serves to hinder or prevent the (poly)phenoloxidase reaction between the ready-to-bake cookie dough and the cinnamon. The barrier sequesters the cinnamon from the dough until the dough is heated during baking or cooking, releasing the cinnamon into the dough to provide the desired flavor and aroma associated with freshly prepared cinnamon cookies.

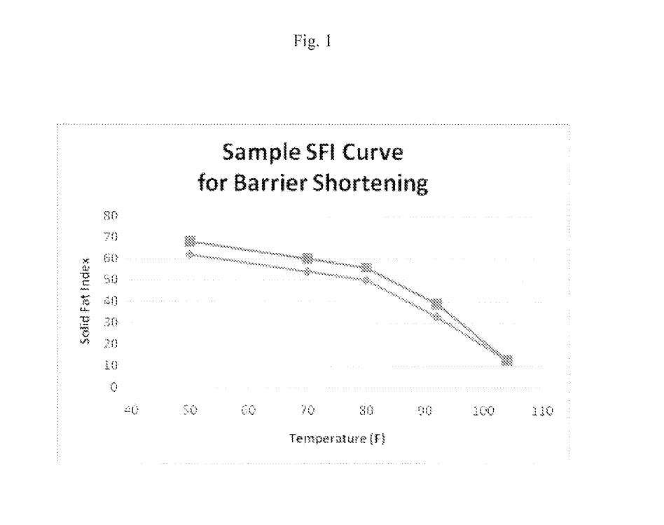

The barrier used in the present invention can be any food-safe ingredient that is able to sequester the substrate components in cinnamon from the flour enzymes in the dough. One example of a suitable barrier is a fat, such as a fat with a high solid fat index, or SFI. As used herein, a “high SFI fat” shall refer to a fat having an SFI value of at least about 65+/−3 at temperatures of about 50° F. or below. Although high SFI fats are not typically used in cookie dough, it was found that the use of a high SFI fat to form the barrier coating of the present invention does not have any undesirable impact on the dough or the finished product. FIG. 1 shows a number of SFI profiles of fats suitable for use in the present invention.

The cinnamon useful in the present invention can be any type of food-grade cinnamon, and can be in powdered, bit, flaked or other suitable form. The level of cinnamon in the dough product of the present invention can vary depending on the desired cinnamon (or other) flavor intensity in the finished product. In some embodiments, the level of cinnamon can range from 0.1% to 10% by weight of the dough. Other embodiments include levels of cinnamon of up to about 20% by weight of the dough, or even higher.

The barrier and the cinnamon are combined sufficiently to coat the cinnamon prior to being mixed in with the other dough ingredients. The cinnamon may also optionally be combined with other ingredients, such as sugar, prior to being coated with the barrier ingredient and combined with the remaining dough ingredients. In one embodiment of the present invention, a coated cinnamon ingredient including between about 35% to 95% by weight high SFI fat, and between about 5% to about 65% by weight cinnamon or a combination of cinnamon and sugar, can be used to prepare a barrier coated cinnamon-containing dough.

The cinnamon-containing dough is then further processed and packaged using conventional means, and can be stored for the same period of time as other ready-to-bake cookie dough products, substantially without the formation of gray dough. In general, ready-to-bake cookie dough products can be stored under refrigeration temperatures of about 40° F. or less for up to about 120 days, and under frozen temperatures of about 0° F. for up to about 6 months to 12 months.

Because of the sequestration effects of the barrier, it was surprisingly discovered that the composition of the headspace gas becomes less significant in the context of reducing or eliminating the formation of gray dough. In fact, it was discovered that no special processing or packaging is needed to prevent the formation of gray dough when using the product of the present invention. As a result, the cookie dough product of the present invention can be packaged and stored in any conventional food-safe packaging, including packaging with a gas-containing headspace, without the need for oxygen scavengers or other oxygen-depleting mechanisms.

Although the present application refers to ready-to-bake cinnamon cookie dough, other ingredients typically found in freshly prepared sweet and savory bakery products can included in all types of ready-to-bake dough products using the barrier system in accordance with the present invention, with a significant reduction or elimination of gray dough or other detrimental effects on the dough. Examples of such ingredients include: spices such as nutmeg, cardamom, poppy seeds, and the like; herbs such as rosemary or basil; flavorings, such as fruit pieces, nuts, onion or garlic, and the like. These additional ingredients can be present at any level in the dough, depending on the desired organoleptic properties of the finished product.

The following example is intended to demonstrate an embodiment of the present invention, but in no way limits the scope of the present invention.

### Example I

Cookie dough was made according to the formulas shown in Table 1. The cookie dough in column A is a sugar cookie dough containing uncoated cinnamon particles. The dough in column B is a plain sugar cookie dough without any cinnamon, and the dough in column C is a sugar cookie dough containing barrier-coated cinnamon bits in accordance with the present invention.

TABLE I

| | Dough A | Dough B | Dough C |
|---|---|---|---|
| Ingredient | % by weight | % by weight | % by weight |
| Shortening | 19.0 | 20.7 | 19.0 |
| Sugar | 31.0 | 33.7 | 31.0 |
| Water | 8.5 | 9.3 | 8.5 |
| Flour | 31.0 | 33.7 | 31.0 |
| Egg Solids | 1.5 | 1.6 | 1.5 |
| Leavening | 0.5 | 0.5 | 0.5 |
| Flavor | 0.5 | 0.5 | 0.5 |
| Uncoated cinnamon particle | 8.0 | — | — |
| Coated cinnamon particle | — | — | 8.0 |
| Total | 100.0 | 100.0 | 100.0 |

Sugar and shortening were first creamed together using a conventional lab bench mixer (KitchenAid® or Hobart® brands of mixers), and the remaining ingredients, except for the cinnamon bits, were added and mixed until blended. The cinnamon bits were added last, and blended with the other ingredients until uniformly mixed.

Cookie pucks weighing approximately 20 g each were formed and packed into trays. The trays were then placed in plastic pouch bags and stored. Some pouches were stored under frozen conditions at about 0° F., and some were stored under refrigeration conditions at about 40° F.

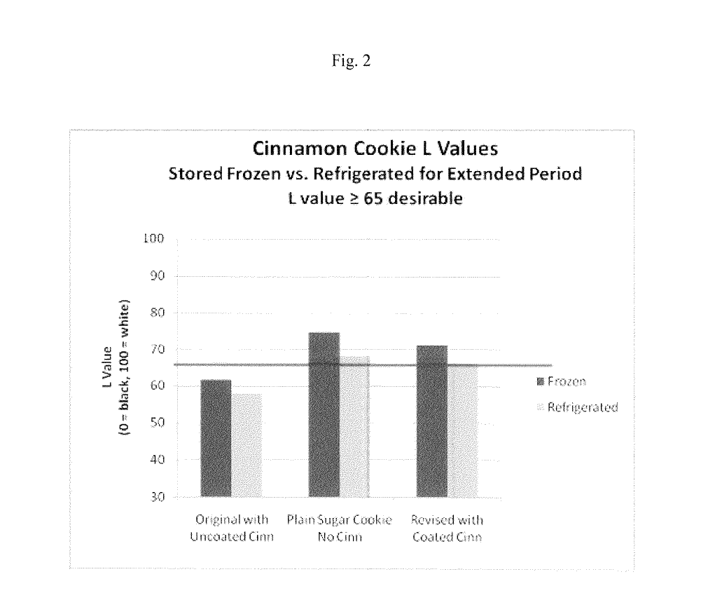

At regular intervals during extended storage conditions, the color of the cookie dough pucks was measured for color using a Minolta® Chroma Meter™, Model CR200. Using this device, the “L” values were determined, wherein an L value of 0 represents dark/black and an L value of 100 represents light/white. Using this measurement technique, it was found that dough products with an L value of at least 65 were deemed acceptable in color and not considered gray. A graphical representation of the L values measured from each of the ready-to-bake cookie dough products, under both frozen and refrigerated conditions, is shown in FIG. 2. At least three samples of each variable were measured for color, and the L value data are summarized in Table II.

TABLE II

| | L Values for Cinnamon Cookie Ready-to-Bake Dough | | | | | |
|---|---|---|---|---|---|---|
| | Dough A | | Dough B | | Dough C | |
| | | Refrig- | | Refrig- | | Refrig- |
| | Frozen | erated | Frozen | erated | Frozen | erated |
| Measurement 1 | 61.5 | 57.2 | 75.5 | 68.4 | 74.6 | 65.8 |
| Measurement 2 | 61.0 | 58.2 | 75.3 | 67.9 | 65.6 | 65.9 |
| Measurement 3 | 62.2 | 58.4 | 73.4 | 68.2 | 73.6 | 66.7 |
| Average | 61.6 | 57.9 | 74.7 | 68.2 | 71.2 | 66.1 |

The results demonstrate that refrigerated cookie dough A, containing uncoated cinnamon, produced significant gray dough, with L values of about 58, while refrigerated cookie dough C containing barrier coated cinnamon in accordance with the present invention resulted in a dough color level (L value approximately equal to 66) very similar to the color of plain sugar cookie dough B without cinnamon (L value approximately equal to 68). Cookies baked from refrigerated cookie dough C were visually bright in color and had cinnamon particulates distributed well throughout the cookie.

The results were similar for frozen cookie dough products, with frozen dough A exhibiting gray dough formation, while frozen dough C of the present invention produced a color similar to a plain sugar cookie dough B. At frozen temperatures, the graying reactions are slowed (but not eliminated), due to decreased reaction kinetics.

Although the present invention and it advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, the processes, machines, manufacture, compositions of matter, means, methods, or steps, presently existing or later to be developed that perform substantially the same function or achieve substantially the same result as the corresponding embodiments described herein may be utilized according to the present invention.

1. A packaged, refrigerated or frozen ready-to-bake cookie dough product comprising a barrier-coated ingredient, said ingredient, when used without a barrier coating, being capable of causing the formation of gray dough during extended storage, wherein the ready-to-bake cookie dough product comprising the barrier-coated ingredient exhibits substantially no gray dough formation in the ready-to-bake cookie dough during extended storage.

2. The ready-to-bake cookie dough product of claim 1, wherein the barrier-coated ingredient comprises cinnamon.

3. The ready-to-bake cookie dough product of claim 2, wherein the barrier-coated ingredient further comprises sugar.

4. The ready-to-bake cookie dough product of claim 1, wherein the barrier-coated ingredient is selected from the group consisting of spices, herbs, flavorings, and a combination thereof.

5. The ready-to-bake cookie dough product of claim 1, wherein the barrier-coated ingredient is coated with a fat barrier.

6. The ready-to-bake cookie dough product of claim 5, wherein the fat barrier comprises a high SFI fat.

7. The ready-to-bake cookie dough product of claim 1, wherein the dough is packaged and stored with an oxygen-containing headspace.

8. The ready-to-bake cookie dough product of claim 1, wherein the extended storage comprises a period of time of up to about 12 months.

9. A method of preparing a packaged, refrigerated or frozen ready-to-bake cookie dough product, comprising the steps of:
combining a particulate ingredient with a barrier ingredient to prepare a barrier-coated composition;
adding the barrier-coated composition to additional cookie dough ingredients to make the ready-to-bake cookie dough product; and
placing the ready-to-bake cookie dough product into a package;
wherein the ready-to-bake dough product exhibits substantially no gray dough formation during storage over an extended period of time.

10. The method of claim 9, wherein the particulate ingredient comprises an ingredient that forms gray dough in a dough composition when the dough composition is stored for an extended period of time.

11. The method of claim 9, wherein the particulate ingredient comprises cinnamon.

12. The method of claim 9, wherein the particulate ingredient comprises a combination of cinnamon and sugar.

13. The method of claim 9, wherein the particulate ingredient is selected from the group consisting of spices, herbs, flavorings, and a combination thereof.

14. The method of claim 9, wherein the barrier ingredient comprises a fat.

15. The method of claim 9, wherein the package comprises an oxygen-containing headspace.

16. The method of claim 9, wherein the extended period of time comprises up to about 12 months.
